(19) United States
(12) Patent Application Publication
(10) Pub. No.: US 2020/0269257 A1
(43) Pub. Date: Aug. 27, 2020

(54) CENTRIFUGATION METHOD

(71) Applicant: Hyun Chul JO, Seoul (KR)

(72) Inventor: Hyun Chul JO, Seoul (KR)

(21) Appl. No.: 16/473,412

(22) PCT Filed: Oct. 28, 2016
(86) PCT No.: PCT/KR2016/012261

§ 371 Date: Jun. 25, 2019

(30) Foreign Application Priority Data
Oct. 28, 2016 (KR) 10-2016-0141940

(51) Int. Cl. B04B 5/04; B04B 11/02

(52) U.S. Cl. CPC B04B 5/0442; B04B 2005/0485; B04B 11/02

(57) ABSTRACT

Provided is a centrifugation method for extracting a target component from an object including: providing a centrifugal container including a first space in an upper portion, a second space in a lower portion, a nozzle connecting the first space and the second space, a second plunger movably received in the second space, and a nozzle blocking member to penetrate the center of the second plunger in a longitudinal direction and to linearly move on the second plunger to selectively open/close a lower end of the nozzle; storing the object; interlayer-separating the object by primarily centrifuging the object; passing only the target component in the object; blocking the lower end of the nozzle by means of the nozzle blocking member; resuspending components remaining in the first space and the nozzle while the nozzle is blocked; and extracting a target component resuspended in the first space.

### TECHNICAL FIELD

The present invention relates to a centrifugation method, and more particularly, to a centrifugation method capable of more quickly and simply centrifuging an object to be treated and a centrifugal container capable of compactly implementing such centrifugation.

### TECHNICAL FIELD

In general, the blood may be divided into blood cells, which are solid components, and plasma, which is a liquid component. The blood cells are composed of red blood cells, white blood cells and platelets, and the plasma is mainly composed of water, which includes blood coagulation factors and electrolytes, required for life maintenance.

The blood is a mixture of various components, and a process of separating the blood and extracting specific components for various medical purposes is widely used, in which a blood centrifuging process using a centrifuge and a process of using a specific composition have been widely used.

Among them, the blood centrifuging process means a process of performing interlayer separation using a weight difference of each component constituting the blood by rotating the blood at a predetermined speed. In the case of centrifuging the blood, the heaviest red blood cells form a lower layer (outer side), and white blood cells, the plasma, and serum layers are formed to the top (inside) from the lower layer.

On the other hand, platelet rich plasma (PRP) in the plasma is relatively located in the lower part of the plasma, and is involved in the coagulation or hemostasis of the blood to be used easily during surgery. In addition, the PRP contains growth factors such as cytokine, PDCF, TGF-BETA1, and VEGP, and it has been found in data such as papers that the PRP is beneficial in skin diseases and wound healing.

However, in the related art, there is a problem that an extraction process of extracting a specific component such as platelets from the blood is troublesome and inconvenient.

That is, according to a blood centrifuging process which has been widely used currently, the red blood cells may be centrifuged from the blood through a single centrifugation process, but the platelets may be extracted by centrifuging the red blood cells from the blood and then centrifuging parts other than the red blood cells again. Therefore, in order to extract the platelets, it is inconvenient and cumbersome to undergo centrifugation processes in at least two different centrifugal spaces, and since the blood needs to be transferred in the centrifugation process, there is a problem that the blood is exposed to the outside.

In addition, in the related art, there is a problem that it is difficult to perform a procedure using the specific component immediately after separating a specific component such as platelets after collecting the blood from a patient because the time spent in the separation process of a blood specific component is long.

Accordingly, in recent years, various studies have been conducted on a centrifugation method that enables objects to be treated such as blood to be more quickly and simply centrifuged.

In this regard, PCT Publication No. WO2011-052927 discloses a centrifugation method for separating a buffy coat. However, since the above-described prior art is for separating only pure buffy coat, the operation is troublesome, and since only the process of separating the buffy coat layer directly after centrifugation is performed, a method of controlling the degree of enrichment by a hygienic process cannot be proposed. Above all, in some of the centrifugation processes, there is a very high possibility to be infected by infectious materials because the blood is exposed to air or to the outside.

### DISCLOSURE

### Technical Problem

The present invention provides a centrifugation method capable of extracting a specific component from an object to be treated with more stable and various concentrations.

Particularly, the present invention provides a centrifugation method capable of controlling a composition ratio of a specific component extracted from an object to be treated.

The present invention also provides a centrifugation method capable of easily extracting a specific component from an object to be treated without external exposure of the object to be treated, and capable of preventing deterioration and infection caused by external exposure in advance.

In addition, the present invention provides a centrifugation method capable of further controlling the degree of enrichment by enabling secondary centrifugation.

### Technical Solution

According to an aspect of the present invention, there is provided a centrifugation method for extracting a target component from an object to be processed by centrifugation, comprising: providing a centrifugal container including a first space provided in an upper portion, a second space provided in a lower portion, a nozzle connecting the first space and the second space, a second plunger movably received in the second space and varying a volume of the second space, and a nozzle blocking member provided to penetrate the center of the second plunger in a longitudinal direction and provided to linearly move on the second plunger apart from movement of the second plunger to selectively open/close a lower end of the nozzle; storing the object to be processed in the centrifugal container; interlayer-separating the object to be processed by primarily centrifuging the object to be processed by making the second space face an outside; passing only the target component in the object to be processed which is primarily centrifuged through a lower end of the nozzle by using the second plunger; blocking the lower end of the nozzle by means of the nozzle blocking member; resuspending components remaining in the first space and the nozzle while the nozzle is blocked; and extracting a target component resuspended in the first space using an entry member capable of entering the nozzle blocking member, in which the end of the nozzle blocking member for selectively opening/closing the lower end of the nozzle basically blocks introduction of the object to be processed, which moves in a direction of centrifugal force into the nozzle blocking member in the process of performing the primary centrifugation by maintaining a sealing state.

For reference, the object to be treated in the present invention means a substance to be centrifuged, and the present invention is not restricted or limited by a type and characteristics of the object to be treated. As an example, the blood may be used as the object to be treated, and in some cases, other samples taken from an animal or a human body may be used as the object to be treated instead of the blood.

The centrifugal container includes a first space formed at an upper portion thereof, a second space formed at a lower portion thereof, and a nozzle connecting the two spaces, the second space may vary the internal volume by a second plunger formed therein, and a nozzle blocking member passing through the center of the second plunger moves independently of the second plunger to selectively block the lower end of the nozzle. Here, the shapes, dimensions and materials forming the first and second spaces, and the shapes, dimensions, and materials of the nozzle may be variously defined, and the present invention is limited or restricted by other structures and characteristics of the centrifugal container. In addition, the centrifugal container may be provided in the form of a single container, or may be provided in a form in which two or more containers or members are combined.

An entry port may be formed in the nozzle blocking member and the entry member such as a needle may enter the first space from the outside via the nozzle through the entry port. It is also preferred that the entry port is kept basically closed to prevent a specific component from being introduced or leaked without using the entry port.

When the object to be treated is the blood, while the centrifugation is performed, a first specific component which is relatively heaviest among the components of the blood may be disposed at an outermost side based on the rotation center of the centrifugal container, a boundary layer which is a second heaviest among the components of the blood may be disposed inside the first specific component (at an inner side adjacent to the rotation center of the centrifugal container), and a second specific component which is lightest among the components of the blood may be disposed inside of the boundary layer (at the inner side adjacent to the rotation center of the centrifugal container).

For reference, the first specific component may include a relatively heaviest red blood cell among the components of the blood, the boundary layer may include a buffy coat, and the second specific component may include a relatively light plasma among the components of the blood.

Here, the buffy coat refers to a boundary layer divided by a white thin layer formed of platelets and white blood cells at the boundary between the plasma part (second specific component) of the uppermost layer and the red blood cell layer (first specific component) of the lowest layer when the blood is centrifuged. When the boundary layer is subdivided, platelets are formed at the upper part, white blood cells are formed at the lower part, and red blood cells having a smaller specific gravity may be mixed in the white blood cell layer to be reddish somewhat.

For reference, since the boundary layer is formed as a very thin layer different from the first specific component and the second specific component, it is difficult to visually confirm the thickness of the boundary layer accurately. However, in the present invention, the thickness of the boundary layer may be relatively increased by moving the boundary layer toward the nozzle having a relatively narrow diameter. Therefore, the user may visually confirm the boundary layer moving toward the nozzle.

In addition, according to the present invention, the height of the boundary layer passing through the nozzle may be adjusted to control the composition ratio of the first space and the boundary layer disposed in the nozzle. That is, as the boundary layer passes frequently through the lower end of the nozzle, the composition ratio of the relatively higher second boundary layer component, for example, white blood cells, may be further increased. Therefore, when the object to be treated is blood, it is possible to extract only platelets or extract platelets and white blood cells together by adjusting the height of the boundary layer passing through the lower end of the nozzle.

Meanwhile, the boundary layer may be sensed while the boundary layer passes through the nozzle, and the composition ratio of the boundary layer components disposed in the first space may be adjusted according to a sensing value.

For reference, sensing the boundary layer in the present invention may be understood as sensing the characteristics of the boundary layer component such as the size, density, color, etc., of the boundary layer component using a normal camera, ultrasonic wave, laser, or the like. As an example, in the case of centrifuged blood, the boundary layer component forming the buffy coat may be arranged in the order of large white blood cells, small white blood cells, large platelets, and small platelets from a position far from the rotation center. By sensing the boundary layer, it is possible to sense the boundary between the platelets and the white blood cells and in some cases, it is possible to sense the boundary between the large platelets and the small platelets.

Also, after the lower end of the nozzle is blocked, components in the first space may be mixed through resuspension, and the target component mixed by refluxing may be extracted to the outside. In some cases, it is possible to perform secondary centrifugation after blocking the lower end of the nozzle while the second specific component and the boundary layer component are disposed in the first space. After the secondary centrifugation is performed, the needle is introduced into the nozzle blocking member to partially extract the plasma in the first space, and resuspend the plasma again. Through this process, the concentration degree of the target component in the first space may be adjusted to a higher level, and this process may be performed hygienically without external exposure.

An injection port communicating with the first space may be formed in the container body of the centrifugal container and the object to be treated may be injected to the container through the injection port.

For example, it is possible to form the injection port near the top of the nozzle of the container body, attach a medical valve to the injection port, and inject the object to be treated into the container through the medical valve. However, in this case, the first plunger is pulled to form a negative pressure in the first space, but there may be a limit to making the centrifugal container compact by making the first space large and pulling the first plunger excessively.

As another example, it is possible to form the injection port passing through the first plunger, attach a medical valve to the injection port, and directly inject the object to be treated into the container through the medical valve. In this case, the negative pressure is not formed, so that the first space need not be formed large, and the negative pressure is not formed by the first plunger, so that the size of the container is made small and it is unnecessary to extract the blood more than necessary.

### Advantageous Effects

By the centrifugation method according to the present invention, after extracting the blood by using a separate tool, the blood extracted by the injector is directly injected into the centrifugal container to be subjected to a centrifugation process without a need to transfer the blood to another storage container or tube and a specific component, for example, platelet rich plasma (PRP) can be directly separated from the centrifugal container and immediately extracted without a movement process. Through such a process, it is possible to more hygienically, quickly, and simply extract the specific component from the object to be treated.

Furthermore, according to the present invention, since the boundary layer component can be separated through the nozzle blocking while confirming the height of the boundary layer component passing through the nozzle, it is possible to precisely adjust the composition ratio of the target component. In particular, in recent years, it has been known that the characteristics of platelet rich plasma (PRP) depend greatly on the presence or absence of leukocyte and it is possible to manufacture leukocyte poor PRP or leukocyte rich PRP according to a required situation and it is possible to adjust purity of the PRP.

Further, according to the present invention, the second specific component is extracted from the first space while the nozzle is blocked to adjust the concentration degree of the boundary layer component for the second specific component.

In addition, according to the present invention, in order to extract a specific component from an object to be treated such as blood, the centrifugation can be performed by using a completely closed centrifugal container without a need to expose the object to be treated to the outside or move the object to be treated to another centrifugation space by using a separate movement means, a specific component included in the object to be treated can be more rapidly and easily extracted. In particular, according to the present invention, since the blood can be directly collected by the centrifugation container and the specific component can be extracted to the outside through the entry port, external exposure of the blood can be completely excluded.

Further, according to the present invention, since the boundary layer formed by centrifugation is moved toward the nozzle having a relatively narrow diameter to artificially increase the thickness of the boundary layer, the user can more easily visually observe the position and thickness (height) of the boundary layer.

Moreover, according to the present invention, by sensing the boundary layer that passes through the nozzle by using the sensing unit, it is possible to sense the boundary between the platelets and the white blood cells and in some cases, it is possible to sense the boundary between the large platelets and the small platelets.

Further, according to the present invention, since a specific component can be extracted from an object to be treated in a sealed centrifugal container without exposure or movement of the object to be treated, deterioration and infection due to external exposure can be prevented in advance.

In addition, according to the present invention, the time required for the centrifugation process can be shortened, and the specific component extracted from the object to be treated can be immediately used. For example, after the blood is collected from a patient and a specific component such as a platelet is separated, the patient can immediately perform the procedure using the specific component, and the emergency situation can be coped more effectively.

### DESCRIPTION OF DRAWINGS

FIG. 1 is a block diagram for describing a centrifugation method according to an embodiment of the present invention.

FIG. 2 is a view for describing a storage state of an object to be treated, as the centrifugation method according to an embodiment of the present invention.

FIGS. 3 and 4 are views for describing a centrifugation process and a state of interlayer separation of an object to be treated by centrifugation, as the centrifugation method according to an embodiment of the present invention.

FIG. 5 is a view for describing movement of a boundary layer by volume variation of a first space and a second space, as the centrifugation method according to an embodiment of the present invention.

FIG. 6 is a view for describing a process of sensing a boundary layer passing through a nozzle, as the centrifugation method according to an embodiment of the present invention.

FIGS. 7 and 8 are views for describing a blocking state of a nozzle, as the centrifugation method according to an embodiment of the present invention.

FIG. 9 is a view for describing a resuspension process of a boundary layer component, as the centrifugation method according to an embodiment of the present invention.

FIG. 10 is a view for describing a process of extracting a second specific component and a boundary layer component, as the centrifugation method according to an embodiment of the present invention.

FIG. 11 is a view for describing a process of adjusting the degree of enrichment of a boundary layer component to a second specific component, as the centrifugation method according to an embodiment of the present invention.

FIGS. 12 to 14 are views for describing a centrifugal container to be used for the centrifugation method according to an embodiment of the present invention.

FIGS. 15 to 18 are views for describing another example of an opening and closing means, as the centrifugation method according to an embodiment of the present invention.

FIG. 19 is a view for describing a centrifugation method and a structure of a centrifugal container according to an embodiment of the present invention.

FIG. 20 is a view for describing a cross-sectional structure of the centrifugal container of FIG. 19.

### MODES OF THE INVENTION

Hereinafter, embodiments of the present invention will be described in detail with reference to the accompanying drawings, but the present invention is not limited or restricted to the embodiments. In describing the present invention, a detailed description of well-known functions or configurations may be omitted for clarity of the present invention.

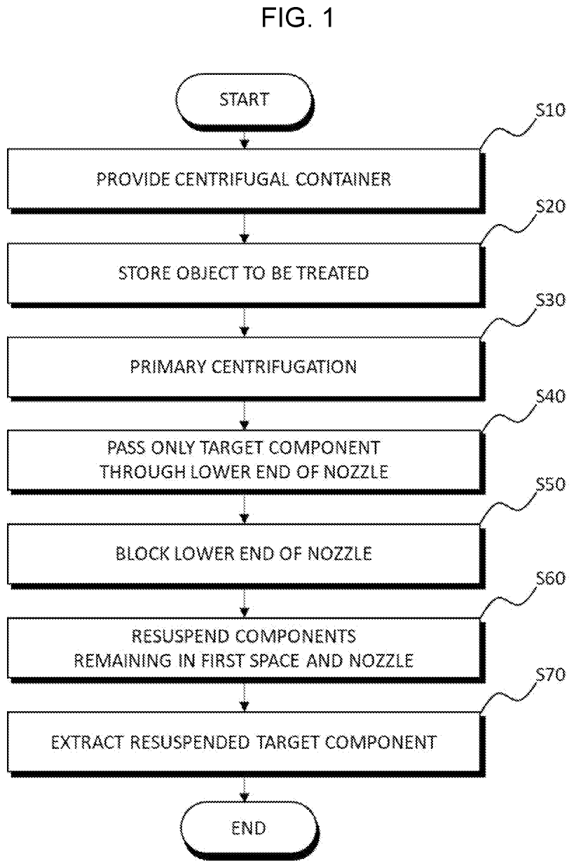

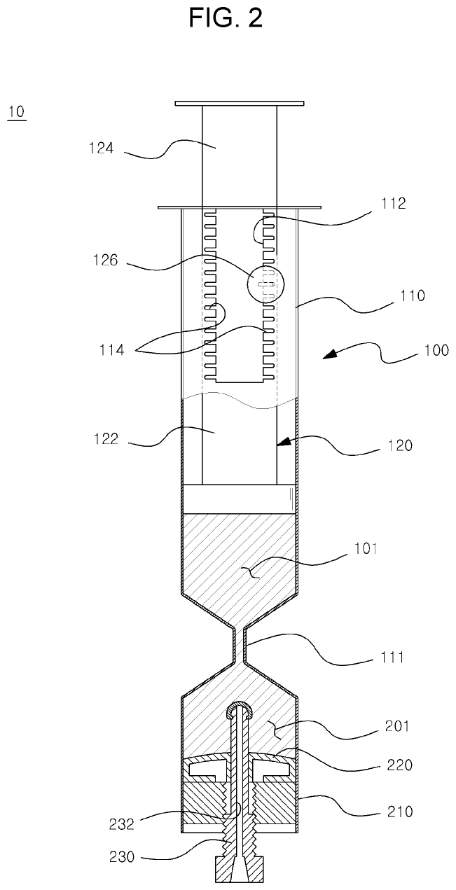

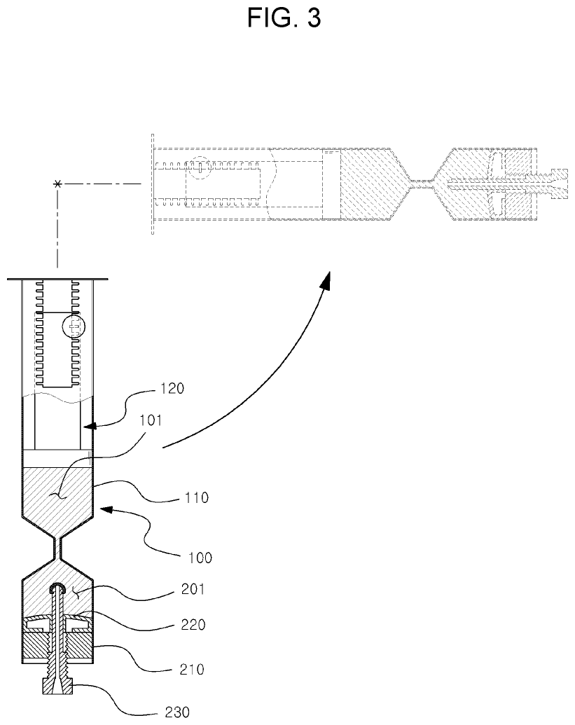

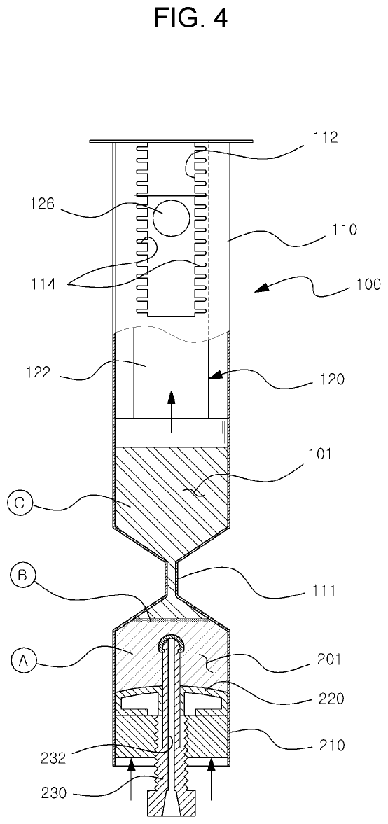

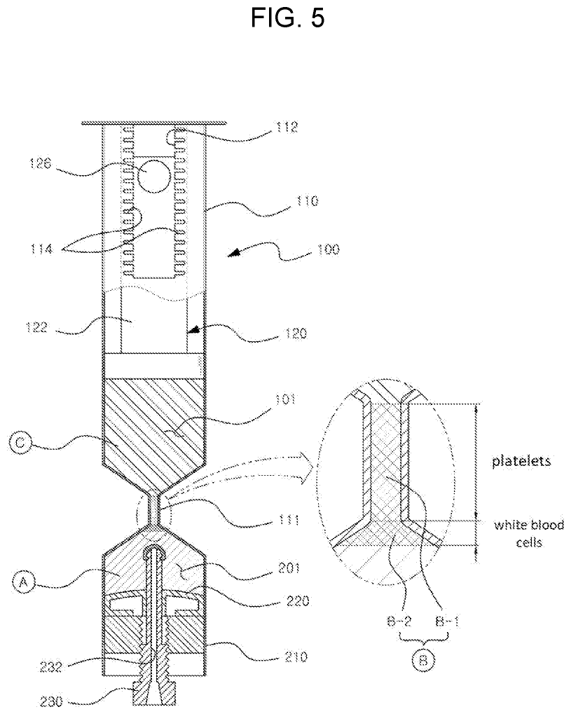

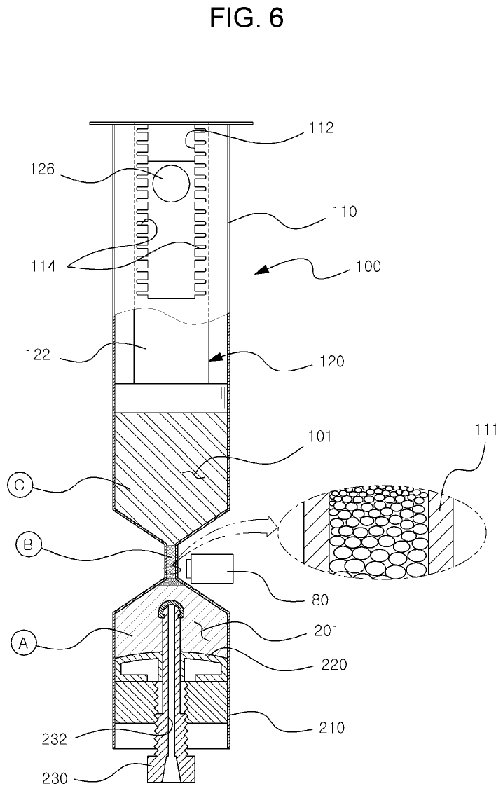

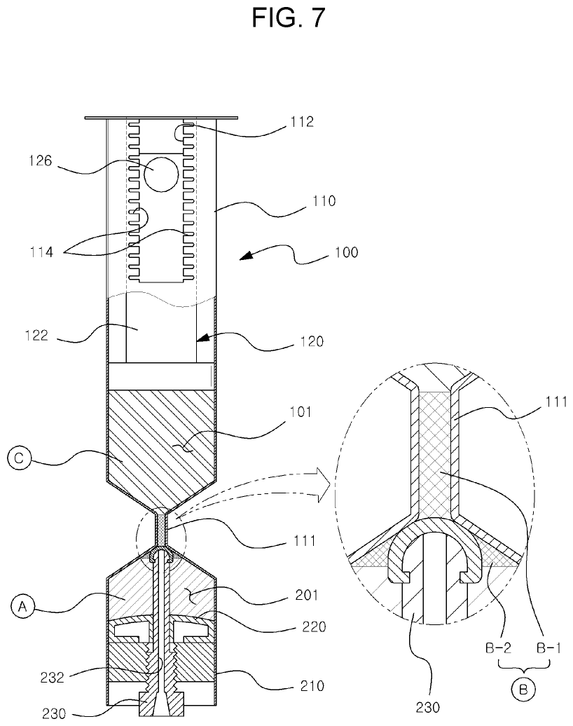

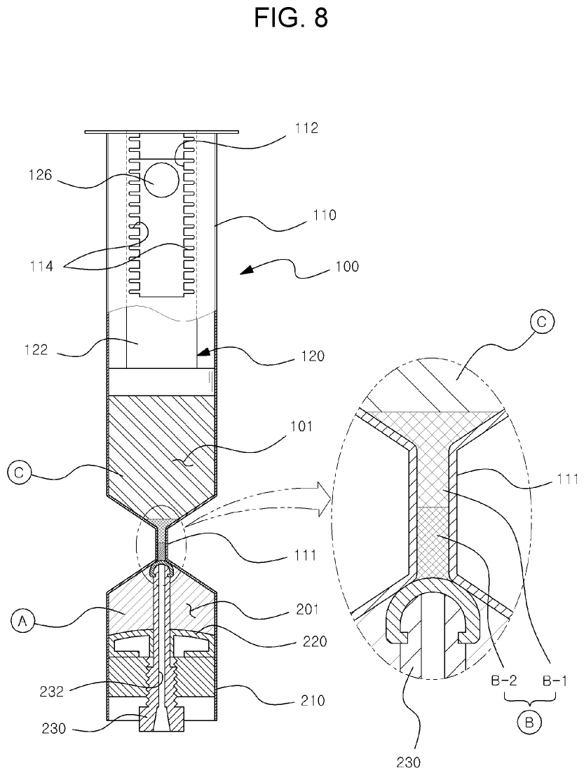

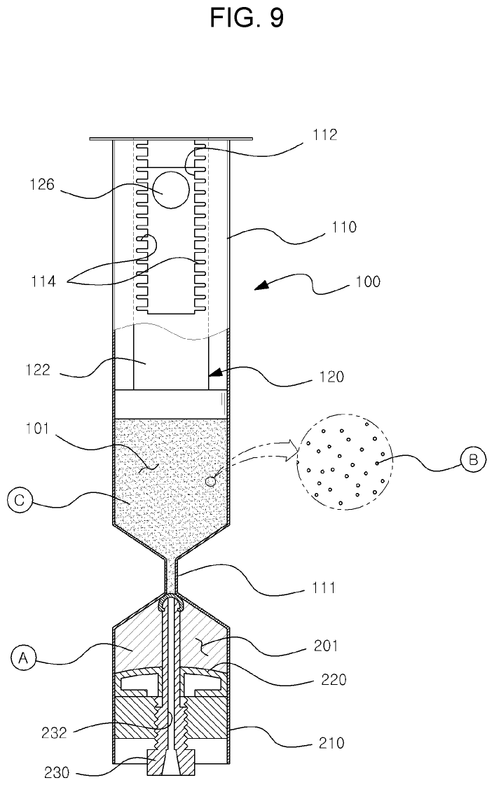

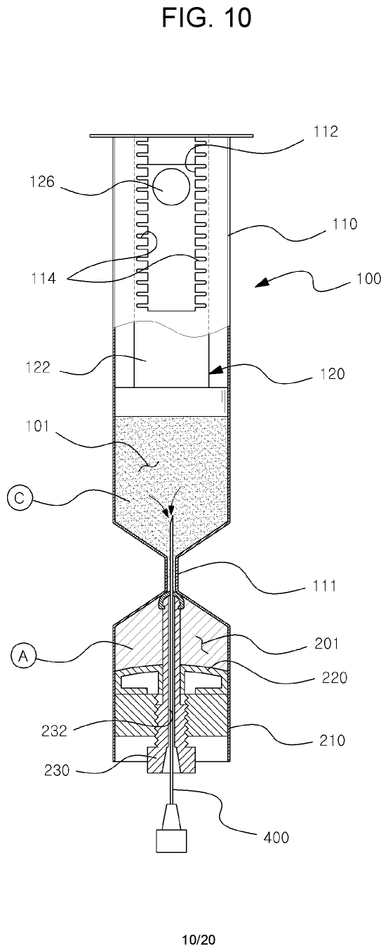

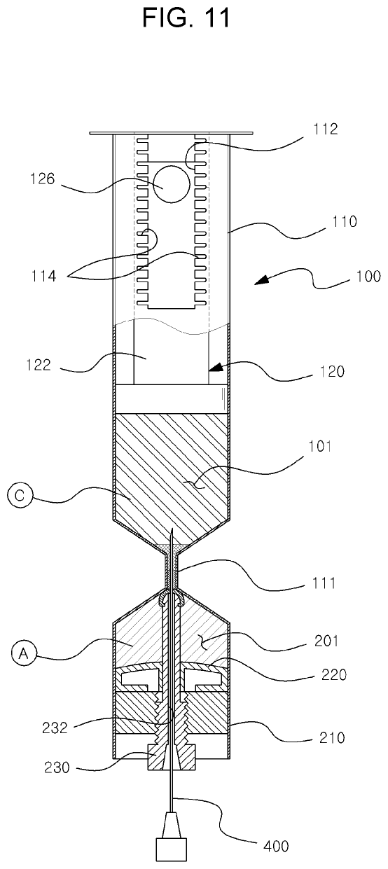

FIG. 1 is a block diagram for describing a centrifugation method according to an embodiment of the present invention, FIG. 2 is a view for describing a storage state of an object to be treated, as the centrifugation method according to an embodiment of the present invention, and FIGS. 3 and 4 are views for describing a centrifugation process and a state of interlayer separation of an object to be treated by centrifugation, as the centrifugation method according to an embodiment of the present invention. FIG. 5 is a view for describing movement of a boundary layer by volume variation of a first space and a second space, as the centrifugation method according to an embodiment of the present invention, FIG. 6 is a view for describing a process of sensing a boundary layer passing through a nozzle, as the centrifugation method according to an embodiment of the present invention, and FIGS. 7 and 8 are views for describing a blocking state of a nozzle, as the centrifugation method according to an embodiment of the present invention. FIG. 9 is a view for describing a resuspension process of a boundary layer component, as the centrifugation method according to an embodiment of the present invention, FIG. 10 is a view for describing a process of extracting a second specific component and a boundary layer component, as the centrifugation method according to an embodiment of the present invention, and FIG. 11 is a view for describing a process of adjusting the concentration degree of a boundary layer component to a second specific component, as the centrifugation method according to an embodiment of the present invention.

A centrifugation method according to an embodiment of the present invention includes a step (S10) of providing a centrifugal container 10 having a first space 101 at the top, a second space 201 at the bottom, and a nozzle 111 connecting the first space 101 and the second space 201, a step (S20) of storing an object to be treated in the centrifugal container 10, a step (S30) of interlayer-separating the object to be treated by primarily centrifuging the object to be treated, a step (S40) of passing only a target component of the centrifuged object to be treated through a lower end of the nozzle using a second plunger, a step (S50) of blocking the lower end of the nozzle by a nozzle blocking member, a step of (S60) of resuspending components remaining in the first space 101 and the nozzle 111 while the nozzle is blocked, and a step (S70) of extracting a target component resuspended in the first space using an entry member capable of entering the nozzle blocking member.

For reference, the object to be treated in the present invention means a substance to be centrifuged, and the present invention is not restricted or limited by a type and characteristics of the object to be treated. Hereinafter, examples in which as the object to be treated, a body fluid including the blood and bone marrow is used will be described. In some cases, other samples taken from an animal or a human body may be used as the object to be treated instead of the body fluid.

Various types of containers having a first space 101 and a second space 201 in which each of the spaces 101 and 201 is connected by a nozzle 111 may be used as the centrifugal container 10 used in the present invention and the present invention is not restricted or limited by a structure and characteristics of the centrifugal container 10.

The centrifugal container 10 may be provided in a form of a single container or may be provided in a form of combining two or more containers or members. Hereinafter, an example in which the centrifugal container 10 is provided in the form of a single container will be described. As an example, the centrifugal container 10 includes a container body 100, a first plunger 120, a second plunger 220, and a nozzle blocking member 230.

The container body 100 includes a first container portion 110 in which the first space 101 is provided and a second container portion 210 in which the second space 201 is provided, 110 and the first container portion 110 and the second container portion 210 are connected by the nozzle 111.

The first container portion 110 may be formed in a hollow cylindrical shape having a predetermined diameter (or capacity). The nozzle 111 is connected to one end of the first container portion 110 and the other end of the first container portion 110 is opened to allow the first plunger 120 to enter.

The first plunger 120 enters the other end of the first container portion 110 and is received in the first space 101 so as to be linearly movable and a volume of the first space 101 may be varied in response to linear movement of the first plunger 120.

The second container portion 210 may be formed in the hollow cylindrical shape having a predetermined diameter (or capacity). The nozzle 210 is connected to one end of the second container portion 210 and the other end of the second container portion 210 is opened to allow the second plunger 220 to enter.

The second plunger 220 enters the other end of the second container portion 210 and is internally (or externally) received in the second space 201 so as to be linearly movable and the volume of the second space 201 may be varied in response to linear movement of the second plunger 220.

For reference, in the exemplary embodiment of the present invention, an example in which each plunger is configured to linearly move in a sliding manner in each variable volume space is described, but in some cases, each plunger may be configured to linearly move in a screw rotation scheme or other schemes with respect to each container portion.

Since the first space 101 and the second space 201 are communicated with each other by the nozzle 111, as the volume of the first space 101 is varied, the volume of the second space 201 may also be varied. Similarly, when the volume of the second space 201 is varied, the volume of the first space 101 may be varied.

A lower portion of the first container portion 110 is formed in the form of a funnel and connected to an upper end of the nozzle 111 and an upper portion of the second container portion 210 is also formed in a reverse funnel and connected to the lower end of the nozzle 111.

The first plunger 120 may be configured to include a plunger body 122 disposed in the first container portion 110 and a plunger rod 124 disposed outside the first container portion 1110 and coupled to the plunger body 122 to be separated and the plunger rod 124 may be separated from the plunger body 122 before performing centrifugation.

Further, a guide slot 112 may be penetratively formed on a wall surface of the first container portion 110 in a longitudinal direction of the first container portion 110 and may include a plunger handle 126 positioned on an outer surface of the first container portion 110 and integrally connected to the plunger body 122, and moving together with the plunger body 122.

That is, the plunger handle 126 is integrally connected to the plunger body 122 to be exposed to the outer surface of the first container portion 110 and the first plunger 120 is operated by the operation of the plunger handle 126 and is configured to move linearly within the first container portion 110. To this end, the guide slot 112 may be penetratively formed on the wall surface of the first container portion 110 and the plunger handle 126 integrally connected to the plunger body 122 may be exposed to the outside through a guide slot 112.

Accordingly, a user may linearly operate the plunger handle 126 by using a finger (e.g., a thumb) while gripping the outer surface of the first container portion 110 and the plunger body 122 may be interlocked and linearly moved by operating the plunger handle 126.

Meanwhile, in the centrifugal container 10, a restriction portion for temporarily restricting a disposition state of the plunger handle 126 may be provided to the first container portion 110. The restriction portion may be provided in various structures to restrict movement of the plunger handle 126 with respect to the first container portion 110. As an example, the restriction portion may include a plurality of restriction grooves 114 spaced apart from an inner wall surface of the guide slot 112 at a predetermined interval and the plunger handle 126 is rotated based on an axial line of the plunger body 122 and selectively received in the restriction groove 114 to be restricted. Moreover, a spacing interval of the restriction grooves 114 and the number of restriction grooves 114 may be appropriately changed according to a required condition and a required design specification.

The nozzle blocking member 230 passes through the center of the plunger 220 and provided onto the second plunger 220 to be linearly moved to selectively block the lower end of the nozzle 111.

The nozzle blocking member 230 may be configured to be linearly moved on the second plunger 220 in various schemes according to the required condition and design specification. As an example, each of the second plunger 220 and the nozzle blocking member 230 may have male and female threads and a tip of the nozzle blocking member 230 may be moved to a position to block the nozzle 111 or to be spaced apart from the nozzle 111.

An entry port 232 may be formed in the nozzle blocking member 230 and the entry member 70 may enter the first space 101 from the outside via the nozzle 111 through the entry port 232.

A sealing cap 232 is formed on the end of the entry port 232 to prevent the object to be treated from being introduced into the entry port 232 from the inside of the container and allows only a needle of the entry member 70 to pass, thereby hygienically managing the object to be treated in the container.

Hereinafter, a centrifugation method according to an embodiment of the present invention will be described with reference to FIGS. 2 to 11.

First, as illustrated in FIG. 2, the blood (object to be treated) is stored in the centrifugal container 10.

A structure in which the first container portion 110 and the second container portion 210 are integrally connected to each other may be configured in such a manner that a separate injection port 105 is formed in the first container portion 110 (or the second container portion) and the blood is injected through the injection port 105. Moreover, the injection port 105 may be configured to be selectively opened/closed by an opening/closing means.

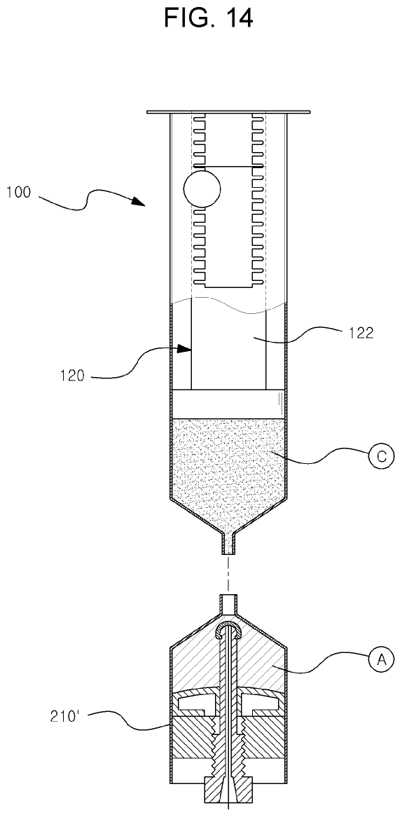

On the other hand, in the case of a structure in which the first container portion 110 and the second container portion 210 are separated from each other, the blood may be injected into the first container portion 110 through the nozzle 111 according to a pressure change due to linear movement of the first plunger 120. In some cases, a separate needle (not illustrated) may be mounted on the tip of the nozzle, and the blood may be supplied directly from the body using the needle. Alternatively, blood stored in a separate storage container may be introduced into the first container portion through the nozzle (see FIG. 14).

For reference, as the volume of any one of the first space 101 and the second space 201 is varied, the volume of the remaining one volume may also be varied together and some of the blood in the first space 101 may be sent to the second space 201.

Next, as illustrated in FIG. 3, the centrifugal container 10 is rotated using a conventional centrifuge (not illustrated) to centrifuge the blood stored therein.

At this time, the second space 201 is disposed toward the outside of a rotation center of the centrifugal container 10 and the plunger rod 124 may be separated from the plunger body 122 before performing the centrifugation. In some cases, it is also possible to perform the centrifugation without separately separating the plunger rod.

The centrifugal container 10 may be mounted on a rotor used in the conventional centrifuge and rotated. As an example, as the rotor on which the centrifugal container 10 may be mounted, a swing out rotor or a fixed angle rotor used in the centrifuge may be generally used and the present invention is not restricted or limited by the type and the characteristics of the rotor. Moreover, the rotation center of the centrifugal container 10 may be appreciated as a rotary shaft (not illustrated) of a rotation means such as the rotor on which the centrifugal container 10 is mounted.

When the centrifugal container 10 is rotated in a state where the second space 201 is disposed so as to face the outside of the rotation center of the centrifugal container 10 as described above, respective components are interlayer-separated by a density difference of each component constituting the blood as illustrated in FIG. 4, and as a result, in this case, a first specific component A which is relatively heaviest among the components of the blood may be disposed in the second space 201 which is an outermost side based on the rotation center of the centrifugal container 10 and a boundary layer B which is second heaviest among the components of the blood may be disposed inside the first specific component A (at an inner side adjacent to the rotation center of the centrifugal container 10) and the second specific component which is lightest among the components of the blood may be disposed inside (at the inner side adjacent to the rotation center of the centrifugal container 10).

For reference, the first specific component A may include a relatively heaviest red blood cell among the components of the blood, the boundary layer B may include a buffy coat, and the second specific component C may include a relatively light plasma among the components of the blood.

Referring to FIG. 5, the volume of the first space 101 and the volume of the second space 201 are varied to move the boundary layer B toward the nozzle 111. As an example, the second plunger 220 of the second container portion 210 is moved upward to move the boundary layer B to the nozzle 111. In some cases, the first plunger of the first container portion is operated to more easily move the boundary layer to the nozzle.

For reference, since the boundary layer B is formed as a very thin layer different from the first specific component A and the second specific component C, it is difficult to visually confirm the thickness of the boundary layer accurately. However, in the present invention, the thickness of the boundary layer B may be relatively increased by moving the boundary layer B toward the nozzle 111 having a relatively narrow diameter. Therefore, the user may visually confirm the boundary layer B moving toward the nozzle 111.

In addition, since one end of the second container portion 210 is formed to have a gradually smaller diameter toward the nozzle 111, the thickness of the boundary layer B passing through the boundary layer B may be further increased along one end of the second container portion 210.

For reference, in the embodiment of the present invention, it is described as an example that the boundary layer B is formed inside the second container portion 210 as the object to be treated is centrifuged, and the boundary layer B is moved upward to the nozzle 111, but in some cases, as the object to be treated is centrifuged, the boundary layer may be configured to be formed inside the first container portion and the boundary layer may be configured to be moved downward toward the nozzle. However, it may be preferable that the first specific component A which preferably contains the red blood cell is separated into the second space 201.

The plunger handle 126 integrally connected to the plunger body 122 is received in the restriction groove 114 formed on the inner wall surface of the guide slot 112, and as a result, the movement of the plunger 120 to the first container portion 110 may be restricted.

Meanwhile, referring to FIG. 6, the boundary layer may include a sensing unit 80 for sensing THE boundary layer while passing through the nozzle 111 and the composition ratio of the boundary layer component disposed in the first space 101 may be adjusted according to a sensing value sensed by the sensing unit 80.

For reference, sensing the boundary layer in the present invention may be understood as sensing the characteristics of the boundary layer component such as the size, density, color, etc., of the boundary layer component using a normal camera, ultrasonic wave, laser, or the like. Hereinafter, an example configured to sense the size of the boundary layer component passing through the nozzle 111 in sensing the boundary layer will be described.

As described above, in the case of centrifuged blood, the boundary layer component forming the buffy coat may be arranged in the order of large white blood cells, small white blood cells, large platelets, and small platelets from a position far from the rotation center. By sensing the boundary layer, it is possible to sense the boundary between the platelets and the white blood cells and in some cases, it is possible to sense the boundary between the large platelets and the small platelets.

As described above, according to the present invention, it is possible to adjust the composition ratio between the boundary layer components arranged in the first space 101 according to the required condition by sensing the boundary layer. In particular, in recent years, it has been known that the characteristics of platelet rich plasma (PRP) depend greatly on the presence or absence of leukocyte and it is possible to manufacture leukocyte poor PRP or leukocyte rich PRP according to a required situation.

Next, as illustrated in FIGS. 7 and 8, the nozzle 111 is blocked in response to a passage amount at which the boundary layer passes through the nozzle 111. As the nozzle 111 is blocked, the second specific component and at least some of the boundary components constituting are disposed in the first space 101 and the composition ratio between the boundary layer components disposed in the first space 101 may be selectively adjusted by blocking the nozzle 111.

That is, as the boundary layer is moved toward the nozzle 111, a first boundary layer component B-1 (platelets) having a relatively low density among the boundary layer components constituting the boundary layer may pass through the nozzle 111 earlier than a second boundary layer component B-2 (white blood cells), and as a result, the lower end of the nozzle 111 is blocked while only the first boundary layer component B-1 passes through the nozzle 111 (see FIG. 7) or the lower end of the nozzle 111 is blocked while both of the first boundary layer component B-1 and the second boundary layer component B-2 pass through the lower end of the nozzle 111, thereby adjusting the composition ratio between the boundary layer components disposed in the first space 101. Accordingly, in the case of the blood, after the nozzle 111 is blocked, only the platelets are disposed alone or the platelets and the white blood cells may be together disposed in the first space 101.

Next, as illustrated in FIG. 9, the boundary layer component (at least any one of the first boundary layer component and the second boundary layer component) may be resuspended together with the second specific component C disposed in the first space 101 by shaking the centrifugal container 10.

For reference, the entry port 232 formed in the nozzle blocking member 230 may maintain a closed state by the sealing cap 234 in the centrifugation state and the blocking state of the nozzle 111.

Next, as illustrated in FIG. 10, the second specific component C and the boundary layer component in the first space 101 may be extracted to the outside in a resuspended state to the outside by using the needle of the entry member 70.

The needle of the entry member 70 may pass through the needle 111 by passing through the sealing cap 234 of the entry port 232 and may be introduced into the first space 101 and a target component in which the second specific component C and the boundary layer component are mixed may be extracted to the outside through the entry member 70.

As the entry member 70, a normal puncture needle such as a spinal needle or a similar tool may be used and the present invention is not restricted or limited by the type and the characteristics of the entry member 70.

Meanwhile, in some cases, it is possible to adjust a concentration degree of the boundary layer component for the second specific component C may be adjusted by extracting only the second specific component C in the first space before resuspending the boundary layer component disposed in the first space.

Referring to FIG. 11, by extracting only the second specific component C from the first space 101 using the entry member 70 before resuspending the boundary layer component disposed in the first space 101, the concentration degree of the boundary layer component for the second specific component may be adjusted. In particular, in the case of the blood, the concentration degree of the PRP may be adjusted by removing an appropriate amount of the plasma using the entry member 70.

In the above-described and illustrated embodiments of the present invention, a single centrifugation process has been described as an example, but in some cases, second centrifugation may be performed after the nozzle is blocked in a state where the second specific component and the boundary layer component are disposed in the first space. After the second centrifugation is performed, the second specific component is sent from the first space to the second space by opening the nozzle and then, only the boundary layer component may be configured to remain in the first space by blocking the nozzle again.

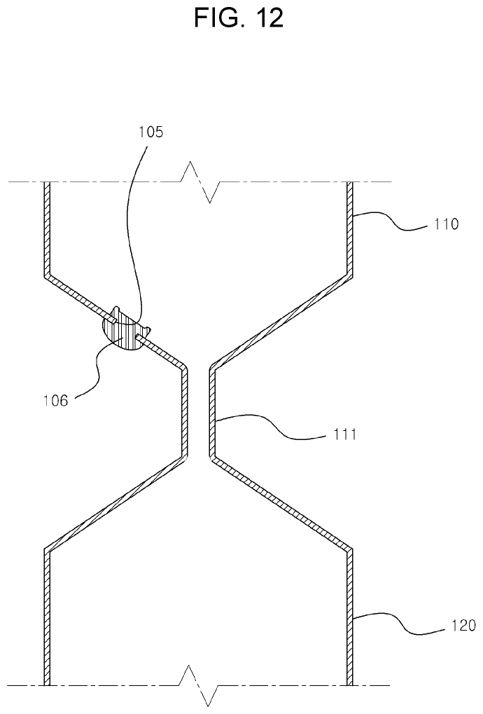

Meanwhile, FIGS. 12 to 14 are views for describing a centrifugal container to be used for the centrifugation method according to an embodiment of the present invention. Moreover, the same or equivalent parts to those of the above-described configuration are denoted by the same or equivalent reference numerals, and a detailed description thereof will be omitted.

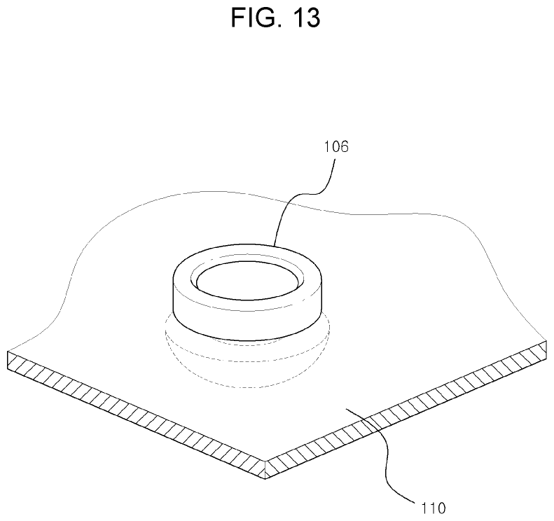

Referring to FIGS. 12 and 13, the injection port 105 may be formed in the centrifugal container 10 which is in communication with the first space 101 and the injection port 105 may be basically opened/closed by the opening/closing means 106.

As an example, the injection port 105 may be formed in the first container portion 110 around the upper end of the nozzle 111 and the blood may be stored in the container through the injection port 105 through an injector.

The opening/closing means 106 may be configured to open/close the injection port 105 in various ways according to the required condition and design specifications. As an example, the opening/closing means may be a rubber stopper made of rubber or a silicon for sealing the injection port 105 to withstand a centrifugal pressure.

Further, according to another embodiment of the present invention, the centrifugal container 10 may be provided in a form in which two or more containers or members are coupled. As an example, referring to FIG. 14, the first container portion 110 and a second container portion 210′ constituting the centrifugal container 10 may be provided in a detachable structure and after the centrifugation is completed, the second container portion 210′ may be separated from the first container portion 110.

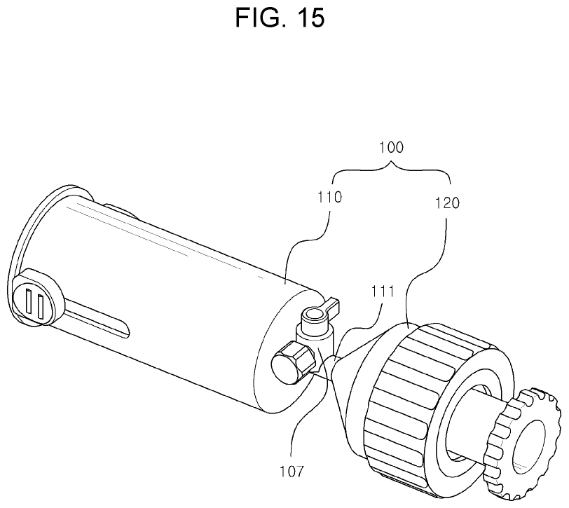

FIGS. 15 to 18 are views for describing another example of an opening and closing means, as the centrifugation method according to an embodiment of the present invention. Moreover, the same or equivalent parts to those of the above-described configuration are denoted by the same or equivalent reference numerals, and a detailed description thereof will be omitted.

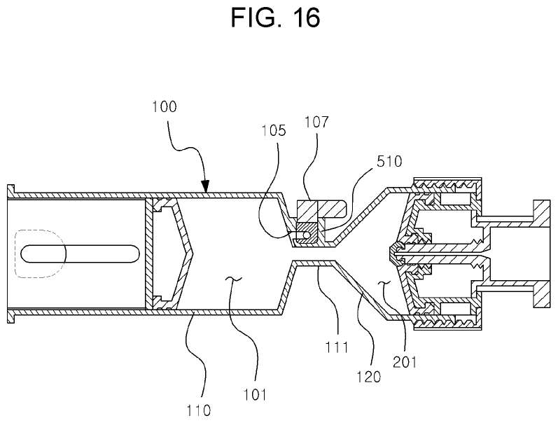

Referring to FIGS. 15 and 16, in the container body 100 of the centrifugal container 10 in which the first container portion 110 having the first space 101 and the second container portion 120 having the second space 201 are integrally connected in a single container form, the injection port 105 communicating with the first space 101 may be formed and the injection port 105 may be selectively opened/closed by a medical valve 107 as the opening/closing means.

The medical valve 107 in the embodiment is provided in the form of a 3-way valve, but the shape and the type of the valve may be variously changed and selected and are not particularly limited only to a medical valve.

An external device such as a tube, the injector, etc., may be connected to the valve 107 and when the external device is not used, an external or internal substance may be prevented from entering or exiting the valve by closing the valve 107.

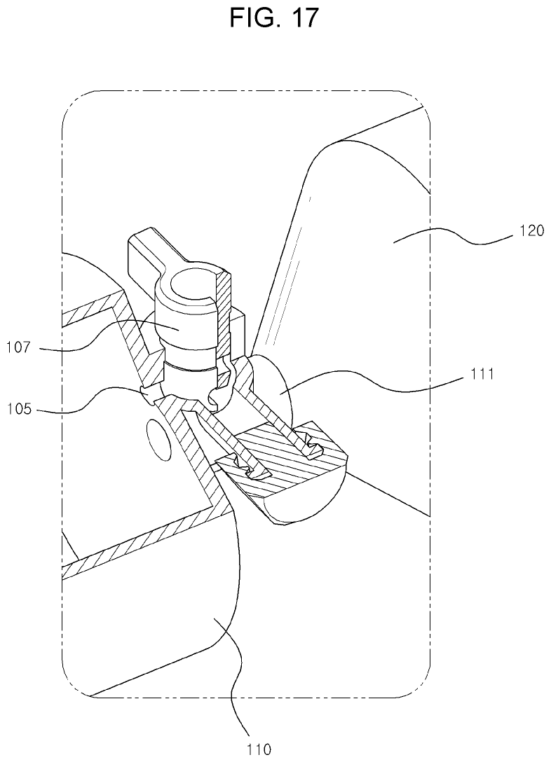

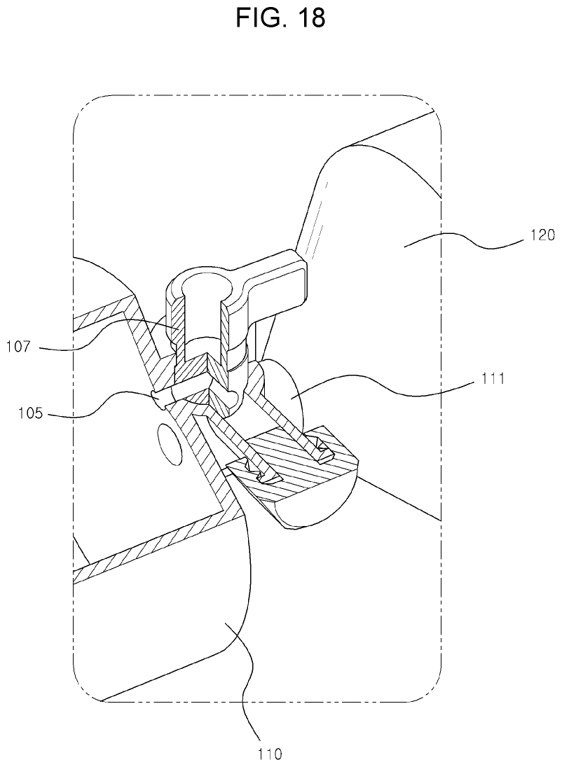

As illustrated in FIG. 17, in the state in which the valve 107 is rotated to a blocking position, a connection passage blocks the injection port 105 and the outside and as illustrated in FIG. 18, in the state in which the valve 107 is rotated to an opening position, the connection passage may maintain a connectable state of the injection port 105 and the outside. Since a connection portion of the valve 107 is basically blocked by an obturator or the sealing cap, introduction of external air or an infected material may be blocked in addition to introduction by the needle, etc.

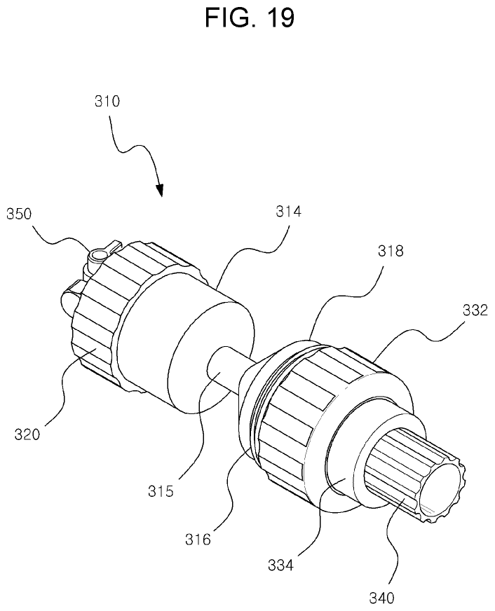

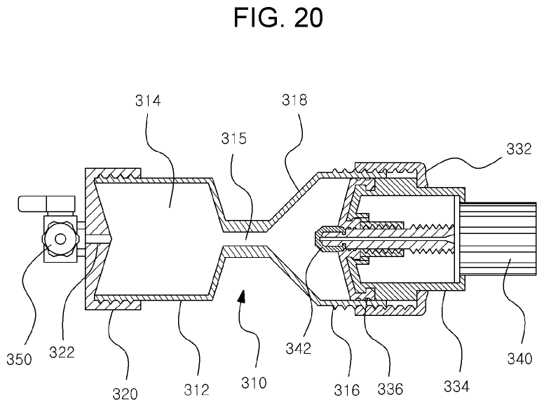

FIG. 19 is a view for describing a centrifugation method and a structure of a centrifugal container according to an embodiment of the present invention and FIG. 20 is a view for describing a cross-sectional structure of the centrifugal container of FIG. 19.

Referring to FIGS. 19 and 20, the centrifugal container according to the embodiment includes a container body 310 including a first container portion 312, a second container portion 316, and a nozzle 315, a first plunger 320 covering an opening port of the first container portion 312, a second plunger 330 covering the opening port of the second container portion 316, a nozzle blocking member 340 penetrating the center of the second plunger 330, and a valve 350 mounted on an injection port 322 formed in the first plunger 320.

In the container body 310, the first space 314 is defined in the first container portion 312, the second space 318 is defined in the second container portion 316, and the first space 314 and the second space 318 are connected by a nozzle 315 having a fairly narrow area.

The second plunger 330 includes a plunger head which is coupled to the opening port of the second container portion 316 in the form of a screw and provided in a cap shape to the outside, and linearly moved inside the second space 318 in response to rotation of the second plunger 330.

Specifically, the second plunger 330 includes a second plunger 332 coupled to an outer surface of the second container portion 316 and having a hole at the center thereof, a second plunger hub 334 provided inside the second container portion 316 and having an outer end coupled to the second plunger cap 332, and a second plunger head 336 mounted on an inner end of the second plunger hub 334. Screw holes capable of receiving the nozzle blocking member 340 are formed in the second plunger hub 334 and the second plunger head 336.

On the contrary, the first plunger 320 includes a plunger head which is coupled to the opening port of the first container portion 312 in the form of the screw and provided in the cap shape to the outside, and linearly moved inside the first space 314 in response to rotation of the first plunger 320.

However, the center of the second plunger 330 is penetrated by the nozzle blocking member 340 and the outer surface of the nozzle blocking member 340 and the inner surface of the second plunger 330 are also sealed and coupled in the form of the screw and a long rod-shaped part of the nozzle blocking member 340 may move from the second plunger 330 to block the lower end of the nozzle 315.

In addition, the nozzle blocking member 340 and the rod-shaped part are formed in a hollow shape so that the needle of the inflow member described later may enter and the end of the nozzle blocking member 340 is sealed by the sealing cap 342, thereby preventing the substance from entering or exiting without using the entry member such as the needle.

In contrast, the injection port 322 may be formed in the first plunger 320, and a medical three-way valve 350 may be mounted on the injection port 322. The valve 350 may selectively block and connect the first space 314 and the outside by rotating a knob and the object to be processed such as the blood may be directly stored in the first space by using the injector, etc.

In addition, unlike the other embodiments, the first plunger 320 according to the embodiment is provided in a cap shape that is coupled with the screw rather than a plunger shape of the injector, and a vertical movement range may also be relatively short, thereby achieving a compact size of the entire container.

As described above, the present invention has been described with reference to the preferred embodiments. However, it will be appreciated by those skilled in the art that various modifications and changes of the present invention can be made without departing from the spirit and the scope of the present invention which are defined in the appended claims and their equivalents.

1. A centrifugation method for extracting a target component from an object to be processed by centrifugation, comprising:
providing a centrifugal container including a first space provided in an upper portion, a second space provided in a lower portion, a nozzle connecting the first space and the second space, a second plunger movably received in the second space and varying a volume of the second space, and a nozzle blocking member provided to penetrate the center of the second plunger in a longitudinal direction and provided to linearly move on the second plunger apart from movement of the second plunger to selectively open/close a lower end of the nozzle;
storing the object to be processed in the centrifugal container;
interlayer-separating the object to be processed by primarily centrifuging the object to be processed by making the second space face an outside;
passing only the target component in the object to be processed which is primarily centrifuged through a lower end of the nozzle by using the second plunger;
blocking the lower end of the nozzle by means of the nozzle blocking member;
resuspending components remaining in the first space and the nozzle while the nozzle is blocked; and
extracting a target component resuspended in the first space using an entry member capable of entering the nozzle blocking member,
wherein the end of the nozzle blocking member for selectively opening/closing the lower end of the nozzle basically blocks introduction of the object to be processed, which moves in a direction of centrifugal force into the nozzle blocking member in the process of performing the primary centrifugation by maintaining a sealing state.

2. The centrifugation method of claim 1, further comprising:
before the resuspending of the components remaining in the first space and the nozzle while the nozzle is blocked,
secondarily centrifuging the components remaining the first space and the nozzle by making the first space face the outside while the nozzle is blocked; and
partially extracting a component adjacent to the nozzle in the first space by using an entry member which is capable of enter through the nozzle blocking member,
wherein a concentration degree of the target component is adjusted by adjusting an amount extracted from the first space.

3. The centrifugation method of claim 1, wherein the centrifugal container further includes a first plunger movably received in the first space and varying the volume of the first space, and
in the passing of only the target component in the object to be processed which is primarily centrifuged through the lower end of the nozzle, the first plunger and the second plunger are used.

4. The centrifugation method of claim 3, wherein the centrifugal container includes an injection port which is in communication with the first space, and
the injection port is in communication with the inside of the first space through the first plunger.

5. The centrifugation method of claim 4, wherein a medical valve for selectively blocking or connecting the outside and the first space is mounted on the injection port.

6. The centrifugation method of claim 1, wherein the centrifugal container includes an injection port which is in communication with the first space, and
the injection port is formed around the upper end of the nozzle and is in communication with the inside of the first space.

7. The centrifugation method of claim 6, wherein a medical valve for selectively blocking or connecting the outside and the first space is mounted on the injection port.

8. The centrifugation method of claim 1, further comprising:
sensing the component which passes through the nozzle,
a composition ratio of the components disposed in the first space and the nozzle is enabled to be adjusted according to a sensing value.

9. A centrifugal container used in a centrifugation method for extracting a target component from an object to be processed by centrifugation, comprising:
a container body including a first container portion provided in an upper portion and forming a first space, a second container portion provided in a lower portion and forming a second space, and a nozzle connecting the first space and the second space;
a second plunger movably received in the second space and varying a volume of the second space, and
a nozzle blocking member provided to penetrate the center of the second plunger in a longitudinal direction and provided to linearly move on the second plunger apart from movement of the second plunger to selectively open/close a lower end of the nozzle,
wherein the end of the nozzle blocking member for selectively opening/closing the lower end of the nozzle basically blocks introduction of the object to be processed, which moves in a direction of centrifugal force into the nozzle blocking member in the process of performing a centrifugation by maintaining a sealing state.

10. The centrifugal container of claim 9, wherein the second plunger includes a second plunger coupled to an outer surface of the second container portion and having a hole at the center thereof, a second plunger hub provided inside the second container portion and having an outer end coupled to the second plunger cap, and a second plunger head mounted on an inner end of the second plunger hub, and
the second plunger hub has a screw hole receiving the nozzle blocking member and guiding movement of the nozzle blocking member.

11. The centrifugal container of claim 9, wherein the end of the nozzle blocking member is covered with a sealing cap to basically maintain the end of the nozzle blocking member in the sealing state.

12. The centrifugal container of claim 9, further comprising:
a first plunger movably received in the first space and varying the volume of the first space.

13. The centrifugal container of claim 12, wherein the centrifugal container includes an injection port which is in communication with the first space, and
the injection port is in communication with the inside of the first space through the first plunger.

14. The centrifugal container of claim 13, wherein a medical valve for selectively blocking or connecting the outside and the first space is mounted on the injection port.

15. The centrifugal container of claim 9, wherein the centrifugal container includes an injection port which is in communication with the first space, and
the injection port is formed around the upper end of the nozzle and is in communication with the inside of the first space.

16. The centrifugal container of claim 15, wherein a medical valve for selectively blocking or connecting the outside and the first space is mounted on the injection port.
